(19) United States
(12) Patent Application Publication
(10) Pub. No.: US 2023/0158764 A1
(43) Pub. Date: May 25, 2023

(54) TREAD PART WITH COLOR LINE

(71) Applicant: TOYO TIRE CORPORATION, Itami-shi (JP)

(72) Inventor: Yoshitaka Mizutani, Itami-shi (JP)

(73) Assignee: TOYO TIRE CORPORATION, Itami-shi (JP)

(21) Appl. No.: 17/857,474

(22) Filed: Jul. 5, 2022

(30) Foreign Application Priority Data
Nov. 22, 2021 (JP) 2021-189137

(51) Int. Cl. B29D 30/72

(52) U.S. Cl. CPC B29D 30/72; B29D 2030/726

(57) ABSTRACT

A tread part with a color line includes a tread part that is a rubber extruded shape having a predetermined cross-sectional shape and extending in an extrusion direction, and has a first main surface that constitutes an outer peripheral surface of a green tire in a tire radial direction when the tread part is wound in a cylindrical shape and a pair of opposing wall surfaces that extend in the extrusion direction on the first main surface and face each other in a left-right direction orthogonal to the extrusion direction, and color rubber extending in the extrusion direction between the pair of the opposing wall surfaces on the first main surface.

### CROSS-REFERENCE TO RELATED APPLICATIONS

This application claims priority of Japanese Patent Application No.: 2021-189137 filed on Nov. 22, 2021, the content of which is incorporated herein by reference.

### BACKGROUND OF THE INVENTION

### Technical Field

The present invention relates to a tread part with a color line.

### Related Art

As a tread part, a tread part with a color line for identification and/or a color line as a reference line of an assembling position on an outer surface is known. Japanese Patent Application Laid-Open No. 2000-61999 discloses, as a method for manufacturing a tread part with a color line. The method includes a step of extruding a rubber material into a predetermined cross-sectional shape from a mouthpiece to form a tread part with a protrusion extending along an extrusion direction on an outer surface, and a step of transferring and applying color rubber cement to a top of the protrusion by a wide transfer roller.

### SUMMARY

In the method of Japanese Patent Application Laid-Open No. 2000-61999, by applying a color line by the transfer roller, even when the extruded rubber meanders, the color line is stably applied to the protrusion of the tread part by the wide transfer roller. However, the method of Japanese Patent Application Laid-Open No. 2000-61999 applies color rubber by the transfer roller, and cannot be applied when color rubber is applied using a nozzle.

An object of the present invention is to provide a tread part with a color line in which color rubber can be stably applied to the tread part using a nozzle.

An object of one aspect of the present invention is to provide a tread part with a color line. The tread part is a rubber extruded shape having a predetermined cross-sectional shape and extending in a first direction. The tread part has a first main surface that constitutes an outer peripheral surface of a green tire in a tire radial direction when the tread part is wound in a cylindrical shape. The tread has a pair of opposing wall surfaces that extend in the first direction on the first main surface and face each other in a second direction orthogonal to the first direction. The tread has color rubber extending in the first direction between the pair of opposing wall surfaces on the first main surface.

According to the present invention, when the color rubber is applied to the tread part by nozzle, even if the tread part meanders in a width direction, a tip of the nozzle is easily held between the pair of the opposing wall surfaces. The color rubber is easily applied between the pair of the opposing wall surfaces. That is, since the color rubber can be applied to the tread part while meandering is suppressed, in a pneumatic tire vulcanization molded using the tread part, meandering of a color line made from the color rubber is suppressed. Therefore, the color rubber can be stably applied to the tread part using the nozzle.

A color rubber width dimension which is a length in the second direction of the color rubber may be 67% or more and 133% or less of a wall surface interval which is a length in the second direction on the first main surface between the pair of the opposing wall surfaces.

According to the present configuration, the nozzle for applying the color rubber is easily arranged between the pair of the opposing wall surfaces. When the color rubber width dimension exceeds 133% of the wall surface interval, it is difficult to arrange the nozzle between the pair of the opposing wall surfaces. When the color rubber width dimension is less than 67% of the wall surface interval, the nozzle can move in the width direction of the tread part between the pair of the opposing wall surfaces, so that meandering of the color rubber applied between the pair of the opposing wall surfaces is likely to increase.

A height of the pair of the opposing wall surfaces in a direction orthogonal to the first main surface may be 3 mm or more and 4.5 mm or less.

According to the present configuration, the nozzle for applying the color rubber is easily held between the pair of the opposing wall surfaces. When the height of the pair of the opposing wall surfaces is less than 3 mm, retention of the nozzle by the pair of the opposing wall surfaces is deteriorated. When the height of the pair of the opposing wall surfaces exceeds 4.5 mm, a portion constituting the pair of the opposing wall surfaces tend to flow so as to cover the color rubber at the time of vulcanization molding, and discriminability by the color rubber is deteriorated.

The tread part may have a pair of protrusions protruding from the first main surface and extending in the first direction, and the pair of the opposing wall surfaces may be constituted by a pair of side surfaces facing each other in the second direction among side surfaces of the pair of the protrusions.

The pair of the protrusions may have a triangular cross-sectional shape.

According to the present configuration, the pair of the protrusions can easily configure the pair of the opposing wall surfaces. As compared with a case where a pair of the opposing wall surfaces are constituted by a groove, it is easy to secure an amount of rubber, and it is easy to suppress rubber chipping due to an insufficient amount of rubber at the time of vulcanization molding.

The wall surface interval may be 1.5 mm or more and 6.0 mm or less.

According to the present configuration, since the wall surface interval is 1.5 mm or more and 6.0 mm or less, for example, the nozzle for applying color rubber having a color rubber width dimension of 2.0 mm or more and 4.0 mm or less is easily arranged between the pair of the opposing wall surfaces. In this manner, a color line for the color rubber applied between the pair of the opposing wall surfaces can form part identification.

The wall surface interval may be 0.20 mm or more and 1.50 mm or less.

According to the present configuration, since the wall surface interval is 0.20 mm or more and 1.50 mm or less, for example, the nozzle for applying the color rubber having a color rubber width dimension of 0.25 mm or more and 1.00 mm or less is easily arranged between the pair of the opposing wall surfaces. In this manner, the color rubber applied between the pair of the opposing wall surfaces can configure a reference line serving as a reference of an assembling position when assembling a green tire.

In the cross-sectional shape, the pair of the opposing wall surfaces may be at an angle of 60° or more and 90° or less with respect to the first main surface to be orthogonal to the first main surface or inclined in a direction in which the pair of the opposing wall surfaces are separated from each other.

According to the present configuration, since a region defined between the pair of the opposing wall surfaces, to which the color rubber is applied is set to an appropriate size, a usage amount of the color rubber is optimized.

According to the present invention, in manufacturing a tread member with a color line, color rubber can be stably applied using a nozzle while meandering of the color rubber with respect to the tread part is suppressed.

### BRIEF DESCRIPTION OF THE DRAWINGS

The foregoing and the other features of the present invention will become apparent from the following description and drawings of an illustrative embodiment of the invention in which:

FIG. 1 is a schematic view of an apparatus for manufacturing a tread part according to a first embodiment of the present invention;

FIG. 2 is a front view of a mouthpiece according to an arrow A in FIG. 1;

FIG. 3 is a perspective view of a tread part;

FIG. 4 is a perspective view illustrating application of color rubber to the tread part by a nozzle;

FIG. 5 is a cross-sectional view illustrating a pair of side protrusions taken along line V-V of FIG. 4 together with the nozzle;

FIG. 6 is a cross-sectional view of a pair of center protrusions, like FIG. 5;

FIG. 7 is a diagram schematically illustrating a step of winding the tread part around a forming drum;

FIG. 8 is a perspective view schematically illustrating a green tire;

FIG. 9 is a front view of the mouthpiece according to a second embodiment;

FIG. 10 is a cross-sectional view similar to FIG. 5 and illustrating the tread part extruded from the mouthpiece of FIG. 9;

FIG. 11 is a front view of the mouthpiece according to a third embodiment; and

FIG. 12 is a cross-sectional view similar to FIG. 5 and illustrating the tread part extruded from the mouthpiece of FIG. 11.

### DETAILED DESCRIPTION OF EMBODIMENTS

Hereinafter, an embodiment according to the present invention will be described with reference to the accompanying drawings. Note that description below is merely exemplary in nature and is not intended to limit the present invention, its application, or its use.

### First Embodiment

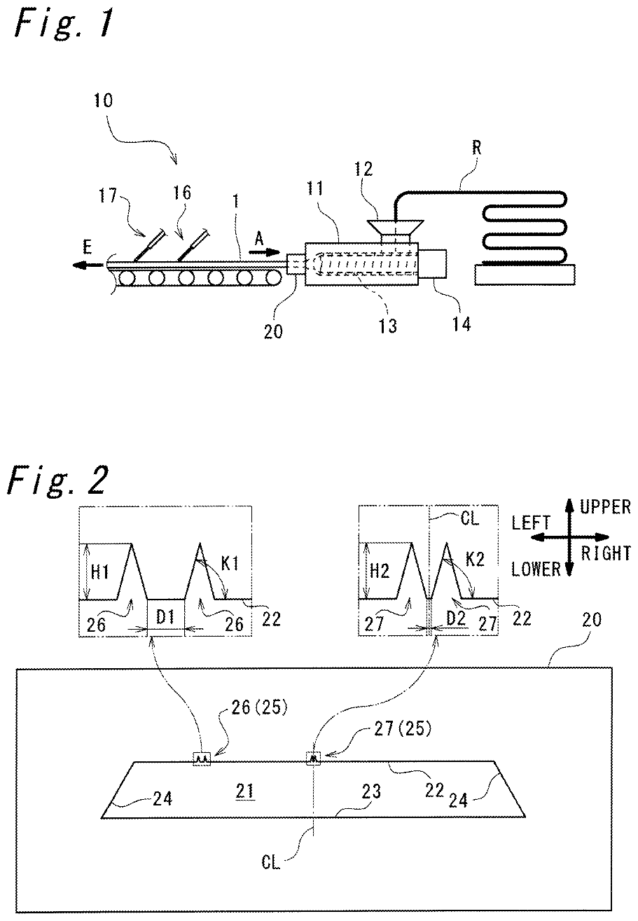

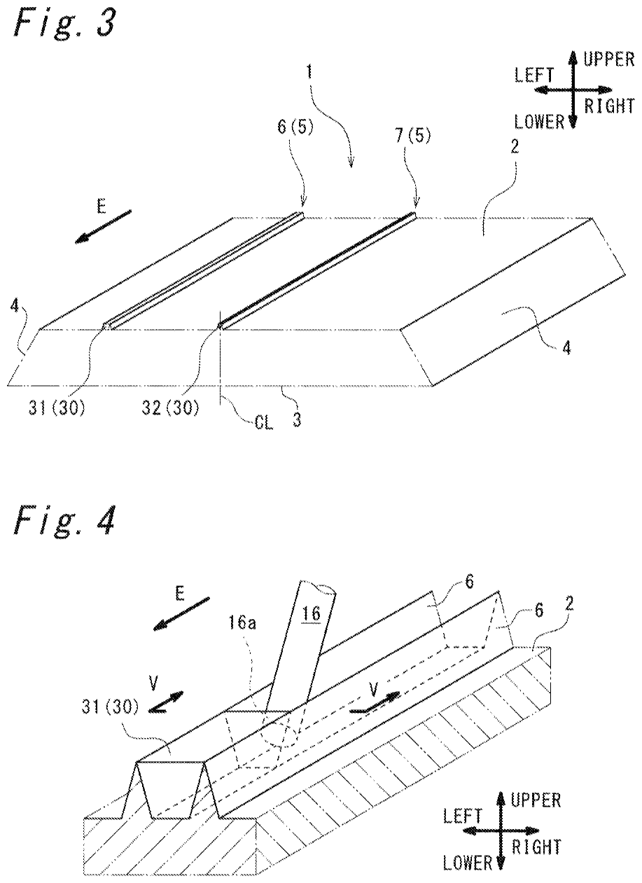

FIG. 1 schematically illustrates a tread production line 10 for producing a tread part 1. As illustrated in FIG. 1, the tread production line 10 includes an extruder 11 that extrudes a rubber material R into a predetermined cross-sectional shape to form the tread part 1, and nozzles 16 and 17 that apply color rubber 30 (see FIG. 3) to the tread part 1.

The extruder 11 includes a hopper 12 into which the rubber material R is supplied, a screw 13 that conveys the rubber material R supplied into the hopper 12 while kneading the rubber material R, a drive source 14 (for example, a motor) that drives the screw 13, and a mouthpiece 20. The extruder 11 rotates the screw 13 by driving of the drive source 14 to knead and heat the rubber material R, and extrudes the rubber material R from the mouthpiece 20 in an extrusion direction E (first direction). The extruded rubber material R constitutes the tread part 1 which is an elongated strip-shaped extruded part having a predetermined cross-sectional shape.

The nozzles 16 and 17 are located on the downstream side in the extrusion direction E with respect to the extruder 11, and apply the color rubber 30 to a surface of the tread part 1 to be conveyed.

FIG. 2 is a front view of the mouthpiece 20 as viewed from an arrow A in FIG. 1. As illustrated in FIG. 2, the mouthpiece 20 has a laterally long opening 21. The opening 21 has an opening upper surface 22 and an opening bottom surface 23 extending in a left-right direction (second direction) orthogonal to the extrusion direction E, and a pair of opening side surfaces 24 extending in a vertical direction. The opening upper surface 22 is shorter than the opening bottom surface 23 in the left-right direction. The pair of the opening side surfaces 24 connect left and right side portions of the opening upper surface 22 and left and right side portions of the opening bottom surface 23, respectively. The opening 21 is formed in a trapezoidal shape that is bilaterally symmetrical with respect to a center line CL in the left-right direction. The rubber material R is extruded in a trapezoidal cross-sectional shape through the opening 21 of the mouthpiece 20.

The opening upper surface 22 is formed with a notch 25 recessed upward and extending in the extrusion direction E. In the present embodiment, the mouthpiece 20 has, as the notch 25, a pair of left and right side notches 26 formed on the left side of the opening upper surface 22 and a pair of left and right center notches 27 formed at the center in the left-right direction of the opening upper surface 22. In the present embodiment, the side notch 26 and the center notch 27 are formed in a triangular cross section by, for example, marking the opening upper surface 22 in the extrusion direction E. In addition, the side notch 26 and the center notch 27 may be formed in an optional cross-sectional shape such as a rectangular shape, a trapezoidal shape, a semicircular shape, or a curved shape.

Each of the pair of the side notches 26 has a recess amount H1 from the opening upper surface 22 of 3 mm or more and 4.5 mm or less. The notch 26 is at an angle K1 with respect to the opening upper surface 22 of 90° or inclined at 60° or more in a direction in which the side notches 26 are separated from each other. A distance D1 in the left-right direction between the pair of the side notches 26 is 1.5 mm or more and 6.0 mm or less.

Similarly, each of the pair of the center notches 27 has a recess amount H2 from the opening upper surface 22 of 3 mm or more and 4.5 mm or less. The notch 27 is at an angle K2 with respect to the opening upper surface 22 of 90° or inclined at 60° or more in a direction in which the center notches 27 are separated from each other. A distance D2 in the left-right direction between the pair of the center notches 27 is 0.20 mm or more and 1.50 mm or less.

FIG. 3 is a perspective view of the tread part 1. The tread part 1 has a cross-sectional shape corresponding to the shape of the opening 21 of the mouthpiece 20. The tread part 1 has a first main surface 2 formed by the opening upper surface 22, a second main surface 3 formed by the opening bottom surface 23, and a pair of tread side surfaces 4 formed by the pair of the opening side surfaces 24. In FIG. 3, the first main surface 2 and the second main surface 3 extend in the left-right direction. The first main surface 2 is shorter in the left-right direction than the second main surface 3. The pair of the tread side surfaces 4 vertically connects left and right side portions of the first main surface 2 and left and right side portions of the second main surface 3. The tread part 1 is an elongated extruded shape having a laterally long cross-sectional shape and extending in the extrusion direction E.

The first main surface is formed with protrusions 5 extending in the extrusion direction E. The protrusions 5 include a pair of side protrusions 6 formed by the pair of the side notches 26 and a pair of center protrusions 7 formed by the pair of the center notches 27.

FIG. 4 is a perspective view illustrating a portion around a tip 16a of the nozzle 16. As illustrated in FIG. 4, the tip 16a of the nozzle 16 is positioned between the pair of the side protrusions 6. When the color rubber 30 is supplied from the nozzle 16, the color rubber 30 is applied between the pair of the side protrusions 6 on the first main surface 2. The color rubber 30 is applied onto the first main surface 2 as the tread part 1 is conveyed in the extrusion direction E, and thus the color rubber 30 extends on the downstream side in the extrusion direction E with respect to the nozzle 16.

FIG. 5 is a cross-sectional view taken along line V-V in FIG. 4, and is a cross-sectional view of the tread part 1 when the pair of the side protrusions 6 and the nozzle 16 positioned between them are viewed from the extrusion direction E. The pair of the side protrusions 6 are formed in a triangular cross section corresponding to a shape of the pair of the side notches 26. Each of the pair of the side protrusions 6 has a protrusion amount X1 from the first main surface 2 of 3 mm or more and 4.5 mm or less. The side protrusion 6 is at an angle Y1 with respect to the first main surface 2 of 90° or is inclined at 60° or more in a direction in which the side protrusions 6 are separated from each other. An inner diameter W1 of the nozzle 16 is 67% or more and 133% or less of a distance Z1 (wall surface interval) in the left-right direction on the first main surface 2 between the pair of the side protrusions 6. The inner diameter W1 of the nozzle 16 is 2.0 mm or more and 4.0 mm or less. Therefore, the distance Z1 between a pair of opposing wall surfaces 6a on the first main surface 2 is 1.5 mm or more and 6.0 mm or less.

In the present embodiment, since the inner diameter W1 of the nozzle 16 is 3.0 mm, the distance Z1 between the pair of the side protrusions 6 is 2 mm or more and 4 mm or less. In other words, the distance D1 between the pair of the side notches 26 in the mouthpiece 20 is set such that the distance Z1 between the pair of the side protrusions 6 falls within the above range. The pair of the side protrusions 6 has the opposing wall surfaces 6a facing each other in a width direction (left-right direction in FIG. 5).

The tip 16a of the nozzle 16 is located above the first main surface 2 and below an apex of the pair of the side protrusions 6. That is, the tip 16a of the nozzle 16 is sandwiched in the left-right direction by the pair of the side protrusions 6, that is, the pair of the opposing wall surfaces 6a. In the present embodiment, the distance Z1 between the pair of the side protrusions 6 is set to 2.0 mm. When the color rubber 30 is supplied from the nozzle 16, a side color line 31 extending in the extrusion direction E with a width F1 (color rubber width dimension) corresponding to the inner diameter W1 of the nozzle 16 is formed between the pair of the side protrusions 6 on the first main surface 2. In the present embodiment, the width F1 of the side color line 31 is substantially equal to the inner diameter W1 of the nozzle 16, and it is 2.0 mm or more and 4.0 mm or less.

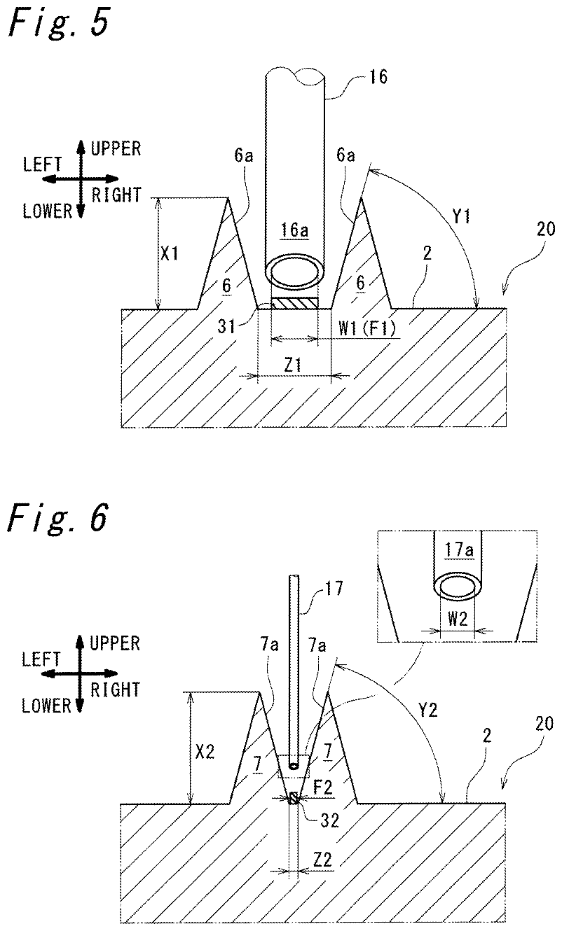

Similarly, FIG. 6 is a cross-sectional view of the tread part 1 when the pair of the center protrusions 7 and the nozzle 17 positioned between them are viewed from the extrusion direction E. The pair of the center protrusions 7 are formed in a triangular cross section corresponding to a shape of the pair of the center notches 27. Each of the pair of the center protrusions 7 has a protrusion amount X2 from the first main surface 2 of 3 mm or more and 4.5 mm or less. The center protrusion 7 is at an angle Y2 with respect to the first main surface 2 of 90° or is inclined at 60° or more in a direction in which the center protrusions 7 are separated from each other. An inner diameter W2 of the nozzle 17 is 67% or more and 133% or less of a distance Z2 (wall surface interval) in the left-right direction on the first main surface 2 between the pair of the center protrusions 7. The inner diameter W2 of the nozzle 17 is 0.25 mm or more and 1.00 mm or less. Therefore, the distance Z2 between a pair of opposing wall surfaces 7a on the first main surface 2 is 0.20 mm or more and 1.50 mm or less.

In the present embodiment, since the inner diameter W2 of the nozzle 17 is 0.5 mm, the distance Z2 between the pair of the center protrusions 7 is 0.3 mm or more and 0.7 mm or less. In other words, the distance D2 between the pair of the center notches 27 in the mouthpiece 20 is set such that the distance Z2 between the pair of the center protrusions 7 falls within the above range. The pair of the center protrusions 7 has the opposing wall surfaces 7a facing each other in the width direction (left-right direction in FIG. 6).

A tip 17a of the nozzle 17 is located above the first main surface 2 and below an apex of the pair of the center protrusions 7. That is, the tip 17a of the nozzle 17 is sandwiched in the left-right direction by the pair of the center protrusions 7, that is, the pair of the opposing wall surfaces 7a. In the present embodiment, the distance Z2 between the pair of the center protrusions 7 is set to 0.25 mm. When the color rubber 30 is supplied from the nozzle 17, a center color line 32 extending in the extrusion direction E with a width F2 (color rubber width dimension) corresponding to the inner diameter W2 of the nozzle 17 is formed between the pair of the center protrusions 7 on the first main surface 2. In the present embodiment, the width F2 of the center color line 32 is substantially equal to the inner diameter W2 of the nozzle 17, and it is 0.25 mm or more and 1.00 mm or less.

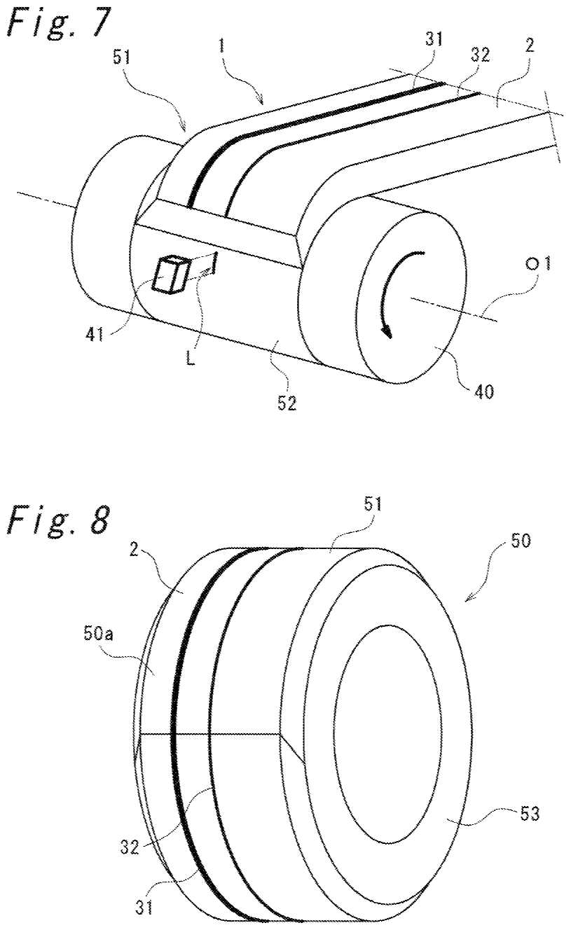

FIG. 7 schematically illustrates a step of forming a tread ring 51 by winding the tread part 1 in which the side color line 31 and the center color line 32 are applied to the first main surface 2 in a cylindrical shape on a forming drum 40. The forming drum 40 rotates about a central axis O1 so that the tread part 1 is wound around an outer peripheral portion. A belt 52 is wound on the forming drum 40 in advance. The tread part 1 is wound on an outer peripheral surface of the belt 52.

At this time, the tread part 1 is wound with a longitudinal direction along a circumferential direction of the forming drum 40 in a posture in which the first main surface 2 is located on the outer peripheral side. In this manner, the tread part 1 is wound in a cylindrical shape such that the side color line 31 and the center color line 32 extend along the outer periphery of the forming drum 40 on the outer peripheral surface.

The forming drum 40 is provided with a laser marker 41 that irradiates a central portion in the width direction with a laser beam. The tread part 1 is wound with the center color line 32 coinciding with a laser beam L emitted from the laser marker 41 toward the forming drum 40 in the width direction of the forming drum 40. In this manner, the tread part 1 is easily wound accurately with respect to the forming drum 40 in a manner that positional deviation in the width direction of the forming drum 40 is suppressed. That is, the center color line 32 constitutes a reference line that is a reference of an assembling position when the tread part 1 is assembled to the forming drum 40.

FIG. 8 is a perspective view of a green tire 50 formed by expanding a separately molded carcass band 53 toward the outer diameter side in a toroidal shape and attaching the carcass band 53 to an inner peripheral surface of the tread ring 51. As illustrated in FIG. 8, an outer peripheral surface 50a of the green tire 50 is constituted by the first main surface 2 of the tread part 1, and the side color line 31 and the center color line 32 extend in a circumferential direction of the green tire 50.

A type of the green tire 50 can be identified by a color, width, position in a tire axial direction, and the like of the side color line 31. Therefore, the side color line 31 constitutes a color line for identification to identify a type of the tread part 1, the green tire 50, and a pneumatic tire (not illustrated) obtained by vulcanization molding the green tire 50.

According to the tread part 1 and the method for manufacturing the tread part 1 according to the above embodiment, operation and effect described below are achieved. Hereinafter, the operation and effect of the pair of the opposing wall surfaces 6a and the side color line 31 will be described. However, the same operation and effect are obtained for the pair of the opposing wall surfaces 7a and the center color line 32 unless otherwise specified, and description of them will be omitted.

(1) The tread part 1 is a rubber extruded shape having a predetermined cross-sectional shape and extending in the extrusion direction E. The tread part 1 has the first main surface 2 that constitutes the outer peripheral surface 50a of the green tire 50 in a tire radial direction when the tread part 1 is wound in a cylindrical shape. The tread part 1 has the pair of the opposing wall surfaces 6a that extend in the extrusion direction E on the first main surface 2 and face each other in the width direction orthogonal to the extrusion direction E. The tread part 1 has the side color line 31 extending in the extrusion direction E between the pair of the opposing wall surfaces 6a on the first main surface 2.

That is, in the method for manufacturing the tread part 1 with the side color line 31, the rubber material R is extruded from the mouthpiece 20 into a predetermined cross-sectional shape in the extrusion direction E. The tread part 1 has the first main surface 2 constituting the outer peripheral surface 50a of the green tire 50 in the tire radial direction when the rubber material R is wound in a cylindrical shape. The pair of the opposing wall surfaces 6a extending in the extrusion direction E on the first main surface 2 and facing each other in the left-right direction orthogonal to the extrusion direction E is formed. The color rubber 30 is applied onto the first main surface 2 by the nozzle 16 arranged between the pair of the opposing wall surfaces 6a with respect to the tread part 1 conveyed in the extrusion direction E to form the side color line 31.

As a result, when the color rubber 30 is applied to the tread part 1 by positioning the nozzle 16 between the pair of the opposing wall surfaces 6a, even if the tread part 1 meanders in the width direction, the tip 16a of the nozzle 16 is easily held between the pair of the side protrusions 6. The color rubber 30 is easily applied between the pair of the opposing wall surfaces 6a. That is, since the color rubber 30 can be applied to the tread part 1 while meandering is suppressed, meandering of the side color line 31 made from the color rubber 30 is suppressed in a pneumatic tire vulcanization molded using the tread part 1. Therefore, the color rubber 30 can be stably applied to the tread part 1 using the nozzle 16.

As in the case of using a plurality of rubber materials having different characteristics in the width direction of the tread part 1 as the rubber material R, the above operation and effect are suitably exhibited. In particular, in the case where the tread part 1 is likely to meander in the width direction at an initial stage until the extrusion of the tread part 1 is stabilized, the above operation and effect are suitably exhibited.

(2) The width F1 of the side color line 31 is 67% or more and 133% or less of the distance Z1 between the pair of the opposing wall surfaces 6a. As a result, the nozzle 16 is easily arranged between the pair of the opposing wall surfaces 6a. When the width F1 of the side color line 31 exceeds 133% of the distance Z1 between the pair of the opposing wall surfaces 6a, it is difficult to arrange the nozzle 16 between the pair of the opposing wall surfaces 6a. When the width F1 of the side color line 31 is less than 67% of the distance Z1 between the pair of the opposing wall surfaces 6a, a movement allowance of the nozzle 16 in the width direction of the tread part 1 between the pair of the opposing wall surfaces 6a increases. As a result, meandering of the side color line 31 between the pair of the opposing wall surfaces 6a is likely to increase.

(3) A height of the pair of the side protrusions 6, that is, the opposing wall surfaces 6a in a direction orthogonal to the first main surface 2 is 3 mm or more and 4.5 mm or less. As a result, the nozzle 16 is easily held between the pair of the opposing wall surfaces 6a. When the height of the pair of the opposing wall surfaces 6a is less than 3 mm, retention of the nozzle 16 by the pair of the opposing wall surfaces 6a is deteriorated. If the height of the pair of the opposing wall surfaces 6a exceeds 4.5 mm, the pair of the side protrusions 6 flow so as to cover the side color line 31 at the time of vulcanization molding and the side color line 31 is easily embedded, and the distinguishability by the side color line 31 is deteriorated.

(4) The pair of the opposing wall surfaces 6a is constituted by the pair of side surfaces facing each other in the width direction in the pair of the side protrusions 6. As a result, the pair of the side protrusions 6 can easily configure the pair of the opposing wall surfaces 6a. As compared with a case where a pair of the opposing wall surfaces are constituted by a groove, it is easy to secure an amount of rubber, and rubber chipping due to an insufficient amount of rubber is suppressed at the time of vulcanization molding.

(5) Regarding the pair of the side protrusions 6, the distance Z1 between the pair of the opposing wall surfaces 6a is 1.5 mm or more and 6.0 mm or less. Accordingly, for example, the nozzle 16 for applying the color rubber 30 having a color rubber width dimension of 2.0 mm or more and 4.0 mm or less is easily arranged between the pair of the opposing wall surfaces 6a. In this manner, a color line for part identification can be configured using the side color line 31 formed by the color rubber 30 applied between the pair of the opposing wall surfaces 6a. When the width of the side color line 31 is less than 2.0 mm, the pair of the side protrusions 6 flow to cover the side color line 31 at the time of vulcanization molding and the side color line 31 is likely to be embedded, and discriminability by the side color line 31 is deteriorated. When the width of the side color line 31 exceeds 4.0 mm, there is a possibility of occurring a defect in which the side color line 31 is transferred to the mold at the time of vulcanization molding.

(6) Regarding the pair of the center protrusions 7, the distance Z2 between the pair of the opposing wall surfaces 7a is 0.20 mm or more and 1.50 mm or less. Accordingly, for example, the nozzle 17 for applying the color rubber 30 having a color rubber width dimension of 0.25 mm or more and 1.00 mm or less is easily arranged between the pair of the opposing wall surfaces 7a. In this manner, a reference line that is a reference of an assembling position when a green tire is assembled using the center color line 32 formed by the color rubber 30 applied between the pair of the opposing wall surfaces 7a can be configured. When the width F2 of the center color line 32 is less than 0.25 mm, it is difficult to stably apply the color rubber by the nozzle 17. If the width F2 of the center color line 32 exceeds 1.00 mm, the reference line at the assembling position is too thick, and thus the assembling accuracy is likely to deteriorate.

(7) The angle Y1 of the opposing wall surfaces 6a of the pair of the side protrusions 6 with respect to the first main surface 2 is 60° or more and 90° or less. In other words, the pair of the opposing wall surfaces 6a are orthogonal to or inclined in a direction in which the opposing wall surfaces 6a are separated from each other with respect to the first main surface 2. As a result, a region, defined between the pair of the opposing wall surfaces 6a to which the color rubber 30 is applied is set to an appropriate size. Accordingly, the usage amount of the color rubber 30 is optimized. As the angle Y1 is larger, that is, closer to 90°, the region to which the color rubber 30 is applied is smaller, and the usage amount of the color rubber 30 is reduced.

### Second Embodiment

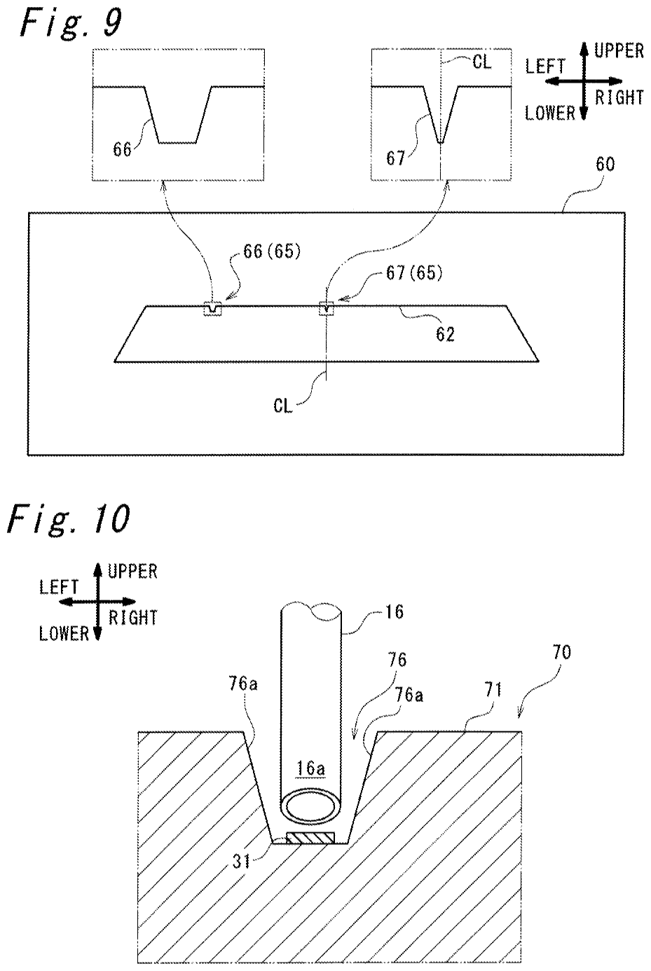

FIG. 9 is a front view similar to FIG. 2 of a mouthpiece 60 according to a second embodiment, and FIG. 10 is an enlarged view similar to FIG. 5 of a tread part 70 extruded from the mouthpiece 60. As illustrated in FIG. 9, the mouthpiece 60 is different from the mouthpiece 20 in that a projections 65 protruding downward on an opening top surface 62 and extending in the extrusion direction E are provided instead of the notch 25.

In the present embodiment, the mouthpiece 60 includes, as the projections 65, a side projection 66 formed on the left side and a center projection 67 formed at the center in the left-right direction of the opening top surface 62. The side projection 66 and the center projection 67 are formed in a trapezoidal shape in which a distance in the left-right direction decreases downward. In addition, the side projection 66 and the center projection 67 may have any cross-sectional shape such as a rectangular shape, a triangular shape, a semicircular shape, or a curved shape.

As illustrated in FIG. 10, in the tread part 70, a side groove 76 recessed downward with respect to a tread top surface 71 is formed by the side projection 66. The side groove 76 is recessed in a trapezoidal shape and has a pair of opposing wall surfaces 76a facing each other in the left-right direction. The tip 16a of the nozzle 16 is arranged between the pair of the opposing wall surfaces 76a. Although not illustrated, a center groove recessed downward in a trapezoidal shape is formed on the tread top surface 71 by the center projection 67, and the tip 17a of the nozzle 17 is arranged between the pair of opposing wall surfaces defining the center groove.

According to the present embodiment, the pair of the opposing wall surfaces 76a can be easily configured by the side groove 76. An increase in an amount of rubber can be suppressed as compared with the case where the pair of the opposing wall surfaces 6a are constituted by the pair of the side protrusions 6 in the first embodiment.

### Third Embodiment

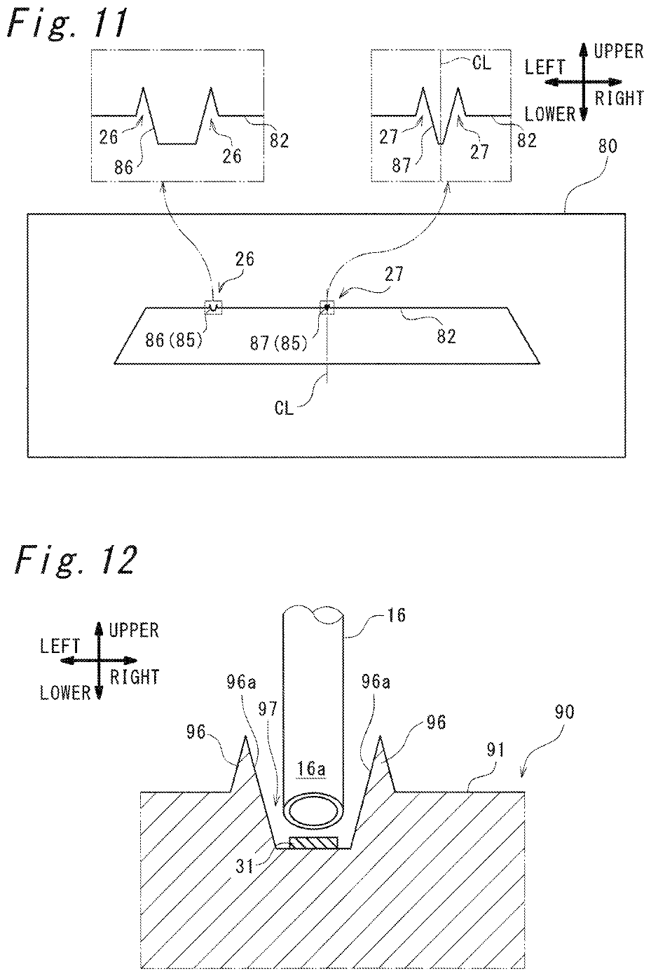

FIG. 11 is a front view similar to FIG. 2 of a mouthpiece 80 according to a third embodiment, and FIG. 12 is an enlarged view similar to FIG. 5 of a tread part 90 extruded from the mouthpiece 80. As illustrated in FIG. 11, the mouthpiece 80 is different from the mouthpiece 20 in that a projections 85 protruding downward on an opening top surface 82 and extending in the extrusion direction E are provided.

In the present embodiment, the mouthpiece 80 includes, as the projections 85, a side projection 86 formed between the pair of the side notches 26, and a center projection 87 formed between the pair of the center notches 27. The side projection 86 and the center projection 87 are formed in a trapezoidal shape in which a distance in the left-right direction decreases downward to be continuous with both side surfaces of the side notch 26 and the center notch 27 facing each other. In addition, the side projection 86 and the center projection 87 may have any cross-sectional shape such as a rectangular shape, a triangular shape, a semicircular shape, or a curved shape.

As illustrated in FIG. 12, the tread part 90 has a pair of side protrusions 96 formed so as to protrude upward from a tread top surface 91 by the pair of the side notches 26, and the side groove 97 formed so as to be recessed downward from the tread top surface 91 by the side projection 86. Side surfaces of the pair of the side protrusions 96 facing each other and side surfaces of the side groove 97 facing each other are continuous in the vertical direction, and constitute a pair of opposing wall surfaces 96a. The tip 16a of the nozzle 16 is arranged between the pair of the opposing wall surfaces 96a. Although not illustrated, a pair of center protrusions and a center groove are similarly formed by the pair of the center notches 27 and the center projection 87, and the tip 17a of the nozzle 17 is arranged between their opposing wall surfaces facing each other.

According to the present embodiment, the pair of the opposing wall surfaces 96a can be easily configured by the pair of the side protrusions 96 and the side groove 97. In particular, it is easy to set a height of the side protrusion 96 to be low and a depth of the side groove 97 to be small, and it is easy to achieve both securing of an amount of rubber and suppressing an increase in the amount of rubber.

It should be noted that the present invention is not limited to the configuration described in the above embodiment, and various modifications are possible.

In the above embodiment, the case where both the side color line 31 and the center color line 32 are provided is described as an example, but the present invention is not limited to this example. For example, the present invention can be applied to various cases such as a case where only the center color line 32 is provided, a case where only the side color line 31 is provided, and a case where a plurality of the side color lines 31 are provided.

What is claimed is:

1. A tread part with a color line, the tread part comprising:
a tread part that is a rubber extruded shape having a predetermined cross-sectional shape and extending in a first direction, and has a first main surface that constitutes an outer peripheral surface of a green tire in a tire radial direction when the tread part is wound in a cylindrical shape and a pair of opposing wall surfaces that extend in the first direction on the first main surface and face each other in a second direction orthogonal to the first direction; and
color rubber extending in the first direction between the pair of opposing wall surfaces on the first main surface.

2. The tread part with a color line according to claim 1, wherein
a color rubber width dimension which is a length in the second direction of the color rubber is 67% or more and 133% or less of a wall surface interval which is a length in the second direction on the first main surface between the pair of opposing wall surfaces.

3. The tread part with a color line according to claim 1, wherein
a height of the pair of opposing wall surfaces in a direction orthogonal to the first main surface is 3 mm or more and 4.5 mm or less.

4. The tread part with a color line according to claim 1, wherein
the tread part has a pair of protrusions protruding from the first main surface and extending in the first direction, and
the pair of opposing wall surfaces are constituted by a pair of side surfaces facing each other in the second direction among side surfaces of the pair of protrusions.

5. The tread part with a color line according to claim 4, wherein
the pair of protrusions have a triangular cross-sectional shape.

6. The tread part with a color line according to claim 1, wherein
the wall surface interval is 1.5 mm or more and 6.0 mm or less.

7. The tread part with a color line according to claim 1, wherein
the wall surface interval is 0.20 mm or more and 1.50 mm or less.

8. The tread part with a color line according to claim 1, wherein
in the cross-sectional shape, the pair of opposing wall surfaces are at an angle of 60° or more and 90° or less with respect to the first main surface so as to be orthogonal to the first main surface or inclined in a direction in which the pair of opposing wall surfaces are separated from each other.

9. The tread part with a color line according to claim 1, wherein
a plurality of rubber materials having different characteristics are provided at different positions in a width direction.
